(19) United States
(12) Patent Application Publication
(10) Pub. No.: US 2002/0000339 A1
(43) Pub. Date: Jan. 3, 2002

(54) Power device of scooter

(76) Inventor: Shui-Te Tsai, Chang Hua (TW)

Correspondence Address: BROWDY AND NEIMARK, P.L.L.C., 624 NINTH STREET, NW, SUITE 300, WASHINGTON, DC, 20001-5303, US

(21) Appl. No.: 09/777,957

(22) Filed: Feb. 7, 2001

(30) Foreign Application Priority Data
Jul. 3, 2000 (TW) 89211401

(51) Int. Cl. B62K 11/00

(52) U.S. Cl. 180/65.1; 180/220

(57) ABSTRACT

A power device of a scooter is formed of two side plates, a carrying portion, an electric unit. The two side plates are extended from the main board of the scooter. The carrying portion is disposed at bottoms of the two side plates to form a receiving space in conjunction with the side plates and the main board. The electric unit is disposed in the receiving space and is well protected by the main board, the side plates, and the carrying portion.

### FIELD OF THE INVENTION

The present invention relates generally to a scooter, and more particularly to a power device of the scooter.

### BACKGROUND OF THE INVENTION

As shown in FIG. 1, a prior art power device 1 of the scooter comprises a battery 2 which is disposed in the lower segment of a handlebar support 4 of the scooter 3. This structure is defective in design in that the battery 2 undermines the esthetic effect of the scooter 3, and that the naked battery 2 is vulnerable to damage caused by impact of a foreign object.

### SUMMARY OF THE INVENTION

The primary objective of the present invention is to provide a scooter with a power device which is free of the drawbacks of the prior art scooter power device described above.

The power device of the present invention is design for use in a scooter comprising a main board, a rear wheel pivoted to the rear end of the main board, a handlebar support fastened with the front end of the main board, and a front wheel pivoted to the bottom end of the handlebar support. The power device comprises two side plates parallel to each other and extending downward from the main board; a carrying portion disposed at the bottom of the two side plates for forming a receiving space in conjunction with the main board and the side plates; and an electric unit disposed in the receiving space for providing the scooter with power.

### BRIEF DESCRIPTION OF THE DRAWINGS

FIG. 1 shows a perspective view of a prior art scooter power device.

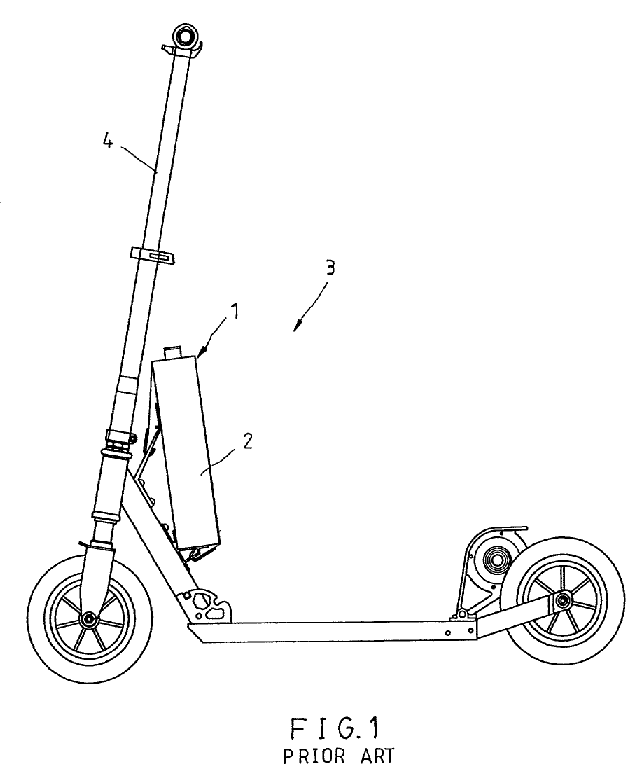

FIG. 2 shows a side view of a first preferred embodiment of the present invention.

FIG. 3 shows an exploded view of the first preferred embodiment of the present invention.

FIG. 4 shows a perspective view of a second preferred embodiment of the present invention.

FIG. 5 shows a perspective view of a third preferred embodiment of the present invention.

FIG. 6 shows an exploded view of a fourth preferred embodiment of the present invention.

### DETAILED DESCRIPTION OF THE INVENTION

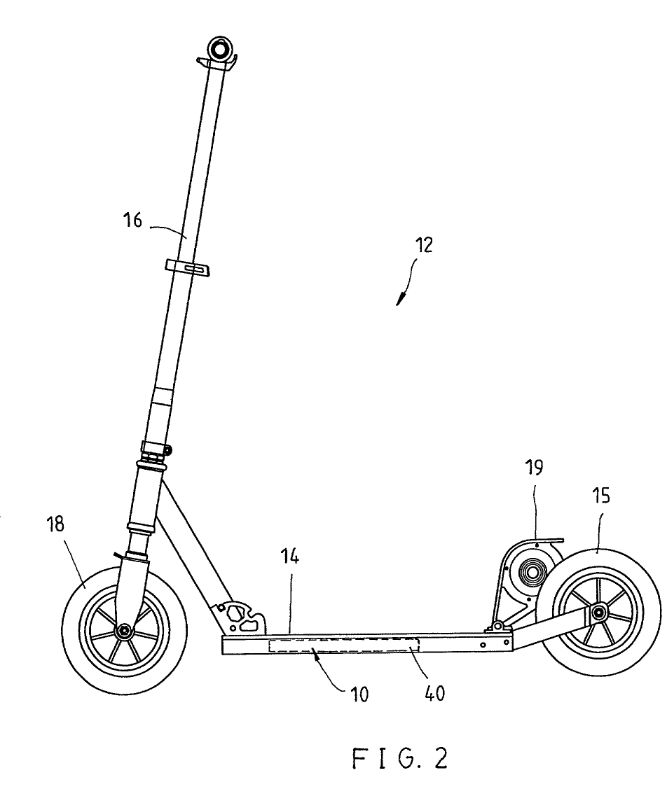

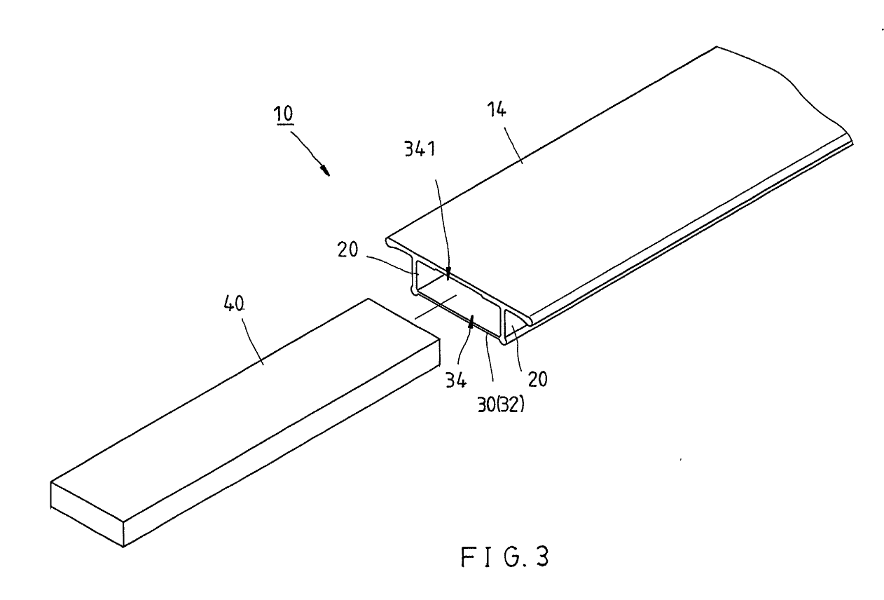

As shown in FIGS. 2 and 3, a power device 10 embodied in the present invention is mounted on a scooter 12 which comprises a long main board 14, a rear wheel 15 pivoted to the rear end of the main board 14, a handlebar support 16 fastened pivotally with the front end of the main board 14, a front wheel 18 pivoted to the bottom end of the handlebar support 16, and a motor 19 mounted on the rear end of the main board 14 for driving the rear wheel 15. The power device 10 comprises two side plates 20, a carrying portion 30, and an electric unit 40.

The side plates 20 are slender and rectangular and are parallel to each other such that they extend downward from the main board 14.

The carrying portion 30 is a rectangular bottom plate 32 for connecting the two side plates 20 such that a receiving space 34 is formed in conjunction with the main board 14 and the side plates 20. The receiving space 34 is provided at two ends thereof with an opening 341.

The electric unit 40 is a battery of a flat platelike construction and is disposed in the receiving space 34 via the opening 341 for driving the motor 19 which in turn drives the rear wheel 15 of the scooter 12.

The main board 14, the side plates 20, and the carrying portion 30 are integrally made of aluminium by extrusion at low cost.

In light of the power device 10 of the present invention being formed of the main board 14, two side plates 20, and the carrying portion 30, the power device 10 looks neat. In addition, the electric unit 40 is well shielded by the main board 14, the side plates 20, and the bottom plate 32.

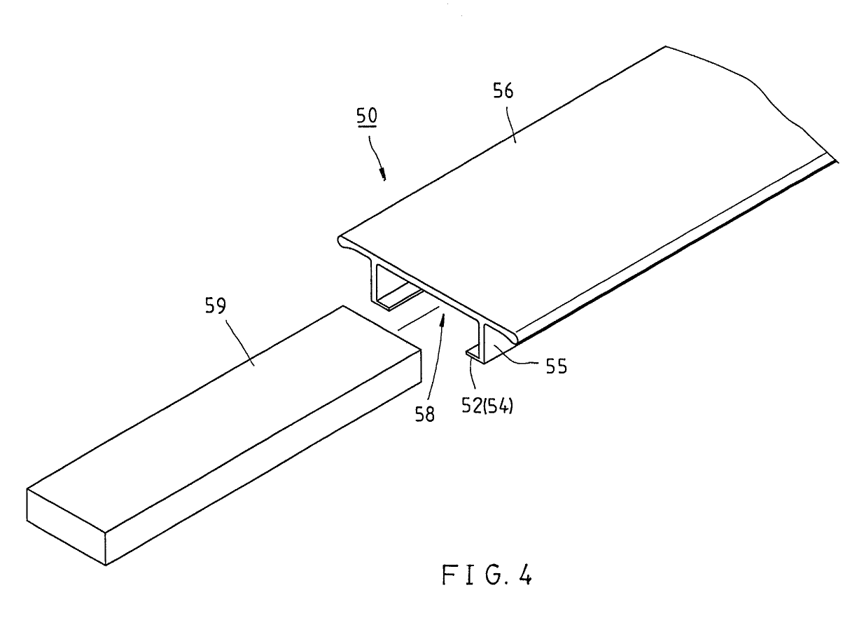

As shown in FIG. 4, a power device 50 of the second preferred embodiment is similar in construction to that of the first preferred embodiment, except that the power device 50 has a carrying portion 52 which comprises two long stop strips 54 extending downward from the bottom of the two side plates 55 such that they are separated from each other at an interval, and that they form a partially-closed receiving space 58 in conjunction with the main board 56 and the side plates 55. The receiving space 58 is intended to accommodate an electric unit 59 for powering the scooter.

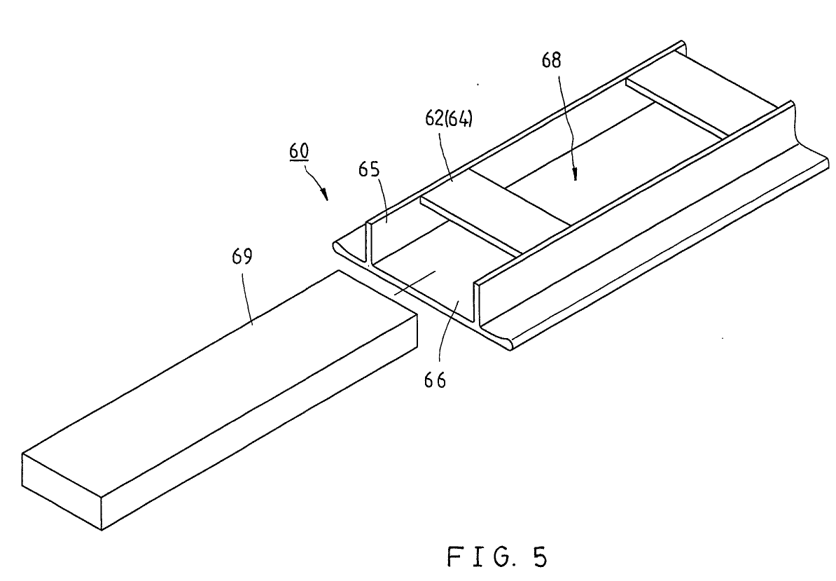

As shown in FIG. 5, a power device 60 of the third preferred embodiment is similar in construction to that of the first preferred embodiment, except that the power device 60 has a carrying portion 62 which is formed of two slender connection strips 64 parallel to each other at an interval for connecting the bottoms of the two side plates 65 such that the carrying portion 62, the main board 66 and the side plates 65 jointly form a partly-closed receiving space 68 in which an electric unit 69 is disposed. The connection strips 64 may be two or more in number.

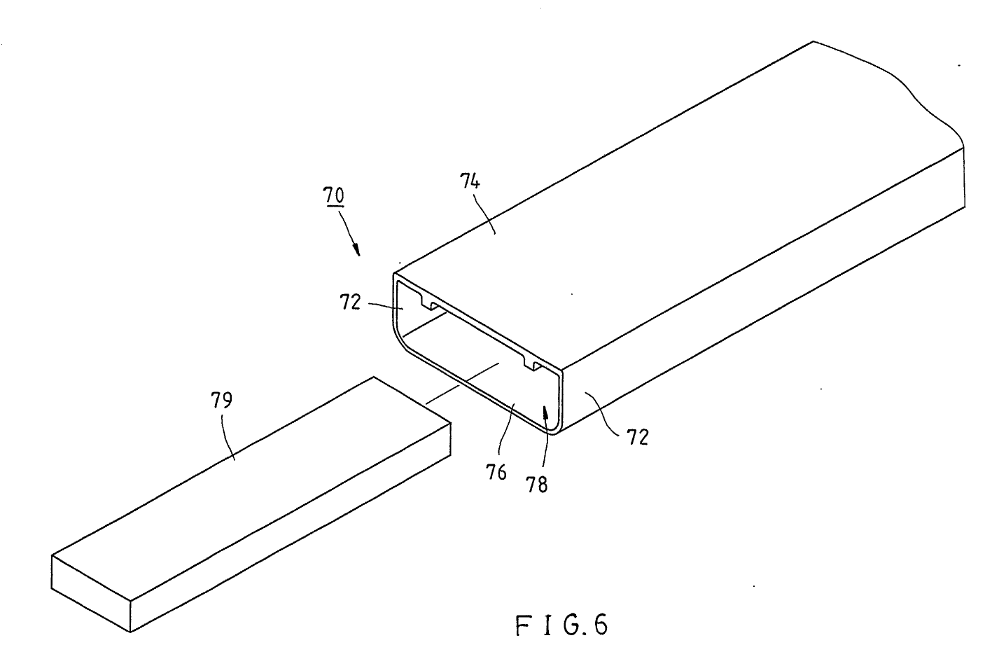

As shown in FIG. 6, a power device 70 of the fourth preferred embodiment of the present invention is similar in construction to that of the first preferred embodiment, with the exception being that the power device 70 comprises two side plates 72 extending downward from two opposite end edges of the main board 74, and a carrying portion 76 forming an arcuate guide angle at the juncture of the carrying portion 76 and the side plates 72. The power device 70 looks neat and has a spacious receiving space 78 for accommodating an electric unit 79.

What is claimed is:

1. A power device of a scooter comprising a main board, a rear wheel pivoted to the rear end of the main board, a handlebar support fastened pivotally with the front end of the main board, and a front wheel pivoted to the bottom end of the handlebar support, said power device comprising:
two side plates parallel to each other and extending downward from the main board;
a carrying portion disposed at bottoms of said two side plates to form a receiving space in conjunction with the main board and said two side plates; and
an electric unit disposed in said receiving space to provide the scooter with electricity.

2. The power device as defined in claim 1, wherein said carrying portion is a bottom plate connecting bottoms of said two side plates.

3. The power device as defined in claim 1, wherein said carrying portion is formed of two stop strips extending downward from bottoms of said two side plates such that said two stop strips are separated from each other at an interval.

4. The power device as defined in claim 1, wherein said carrying portion comprises at least two connection strips which connect bottoms of said to side plates.

5. The power device as defined in claim 1, wherein said electric unit is of a flat platelike construction.

6. The power device as defined in claim 1, wherein said main board, said side plates, and said carrying portion are integrally made of aluminium by extrusion.
